(19) United States
(12) Patent Application Publication
(10) Pub. No.: US 2012/0086918 A1
(43) Pub. Date: Apr. 12, 2012

(54) PROJECTION DISPLAY DEVICE AND METHOD FOR CONTROLLING THE SAME

(75) Inventor: Yoshiyuki Furumi, Shiojiri-shi (JP)

(73) Assignee: Seiko Epson Corporation, Tokyo (JP)

(21) Appl. No.: 13/270,490

(22) Filed: Oct. 11, 2011

(30) Foreign Application Priority Data
Oct. 12, 2010 (JP) 2010-229694

(51) Int. Cl. G03B 21/16

(52) U.S. Cl. 353/52

(57) ABSTRACT

When the operation of a device main body is stopped, control to close an exhaust port shutter is performed, detection as to whether or not the exhaust port shutter is closed is performed, when the exhaust port shutter is not closed, the control to close the exhaust port shutter is retried, when the exhaust port shutter is not closed after the retry, error processing is performed, and, after the error processing, the state transitions to a standby state in which startup is possible.

The entire disclosure of Japanese Patent Application No. 2010-229694, filed Oct. 12, 2010 is expressly incorporated by reference herein.

### BACKGROUND

1. Technical Field

The present invention relates to a projection display device having a shutter that opens and closes an opening for ventilation and a method for controlling the projection display device.

2. Related Art

A projection display device (a projector) having an opening and closing mechanism (a shutter) that opens and closes an exhaust port (an opening for ventilation) and uses a drive motor as a drive source of the opening and closing mechanism has been proposed (see, for example, Japanese Patent No. 3,453,775 (Patent Document 1) and JP-A-2009-98481 (Patent Document 2)). Patent Document 2 describes that processing for closing the opening and closing mechanism is performed one time by power off processing.

However, since it is difficult to determine whether or not the opening and closing mechanism is closed from the outside of a product, there is a possibility that the user will leave the device as it is even when the opening and closing mechanism is not closed. Moreover, there were cases where this kind of opening and closing mechanism is left unclosed due to a temporal malfunction of the opening and closing mechanism.

A state in which the exhaust port is not closed when the power is turned off and the device is stopped is an undesirable state for, in particular, a projection display device to which dust prevention measures are applied so that the device can be used in a dust-prone region, that is, a dustproof projection display device (a dustproof projector).

On the other hand, if it is determined that the projection display device is in an error state when the exhaust port is not closed, the projection display device cannot be started due to an error, making it impossible to use the projection display device.

### SUMMARY

An advantage of some aspects of the invention is to provide a projection display device that can confirm an abnormality in a shutter when the operation is stopped and perform processing corresponding to the abnormality and a method for controlling the projection display device.

A projection display device according to an aspect of the invention includes: a device main body including an image projecting section projecting an image; a shutter that opens and closes an opening for ventilation, the opening of the device main body; a shutter driving section driving the shutter; an opening/closing detecting section detecting an open/closed state of the shutter; and a control section that performs, when stopping the operation of the device main body, controls to close the shutter by the shutter driving section, makes the opening/closing detecting section detect whether or not the shutter is closed, retries the control to close the shutter when the shutter is not closed, performs error processing when the shutter is not closed even with the retry, and, after the error processing, makes the device main body transition to a state in which the device main body can start.

According to this configuration, only when an abnormality in the shutter is confirmed when the operation is stopped and the shutter abnormality cannot be corrected even with the retry, the error processing can be performed. This makes it possible to avoid the circumstances under which the error processing is performed even when the shutter abnormality can be corrected and perform processing corresponding to the abnormality appropriately. In addition, it is possible to start the projection display device even after providing notification about an error indicating a state in which the shutter is not closed.

In the above configuration, the shutter may be opened and closed by the driving of a solenoid, and the shutter driving section may drive the shutter so that the shutter is closed by passing electric current through the solenoid. With this configuration, as compared to a case in which the shutter is driven by a motor so that it is closed, it is possible to close the shutter in a short time. This makes it possible to shorten the time necessary for a retry when the operation is stopped.

With this configuration, even when a malfunction occurs in the solenoid, a biasing member makes it easier to close the shutter. Furthermore, with this configuration, the entry of dust and insects through a suction port is prevented by a dust filter. By closing an exhaust port with the shutter, a vent hole of the projection display device is closed, whereby it is possible to prevent dust and insects from entering the projection display device reliably and avoid the circumstances under which an error indicating that the shutter is not closed when the projection display device is not used, the error which is undesirable from the viewpoint of dustproofing, is left as it is.

According to this configuration, only when an abnormality in the shutter is confirmed when the operation is stopped and the shutter abnormality cannot be corrected even with the retry, the error processing can be performed. This makes it possible to avoid the circumstances under which the error processing is performed even when the shutter abnormality can be corrected and perform processing corresponding to the abnormality appropriately. In addition, it is possible to start the projection display device even after providing notification about an error indicating a state in which the shutter is not closed.

According to the aspect of the invention, only when an abnormality in the shutter is confirmed when the operation is stopped and the shutter abnormality cannot be corrected even with the retry, the error processing can be performed, and it is possible to perform processing corresponding to the abnormality appropriately.

### BRIEF DESCRIPTION OF THE DRAWINGS

The invention will be described with reference to the accompanying drawings, wherein like numbers reference like elements.

FIG. 1 is a diagram showing an internal structure of a projector according to an embodiment of the invention.

FIG. 2 is a block diagram showing a functional configuration of the projector.

FIG. 3 is a perspective view showing an open state of an exhaust port shutter.

FIG. 4 is an exploded perspective view of the exhaust port shutter.

FIG. 5 is a diagram showing a closed state of the exhaust port shutter.

FIG. 6 is a diagram showing a solenoid along with peripheral components.

FIG. 7 is a flowchart showing startup shutter control.

FIG. 8 is a flowchart showing shutter monitoring processing after startup.

FIG. 9 is a flowchart showing operation stop shutter control.

### DESCRIPTION OF EXEMPLARY EMBODIMENTS

Hereinafter, an embodiment of the invention will be described with reference to the drawings.

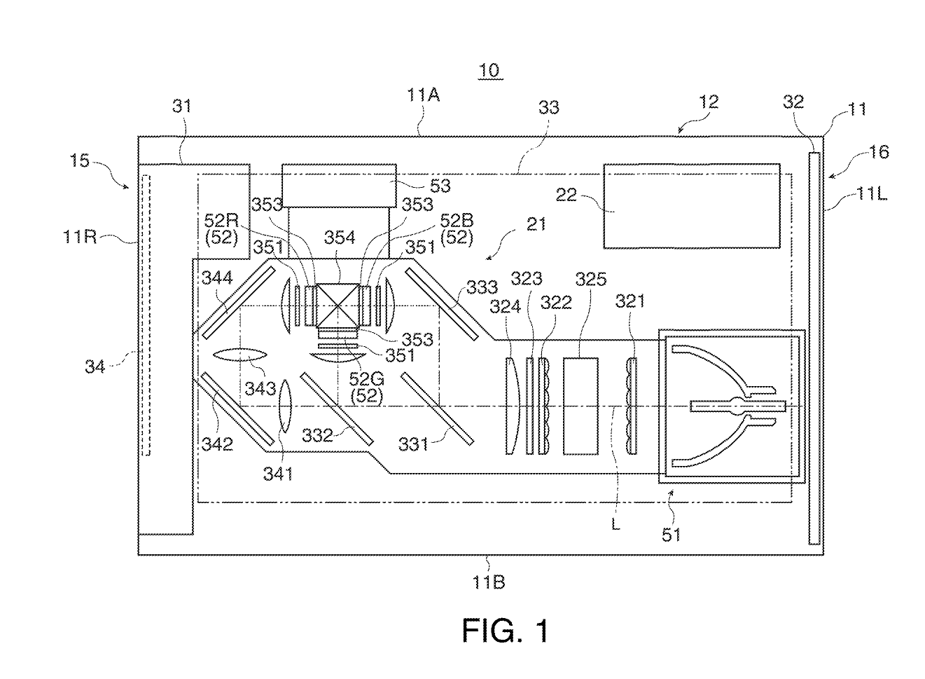

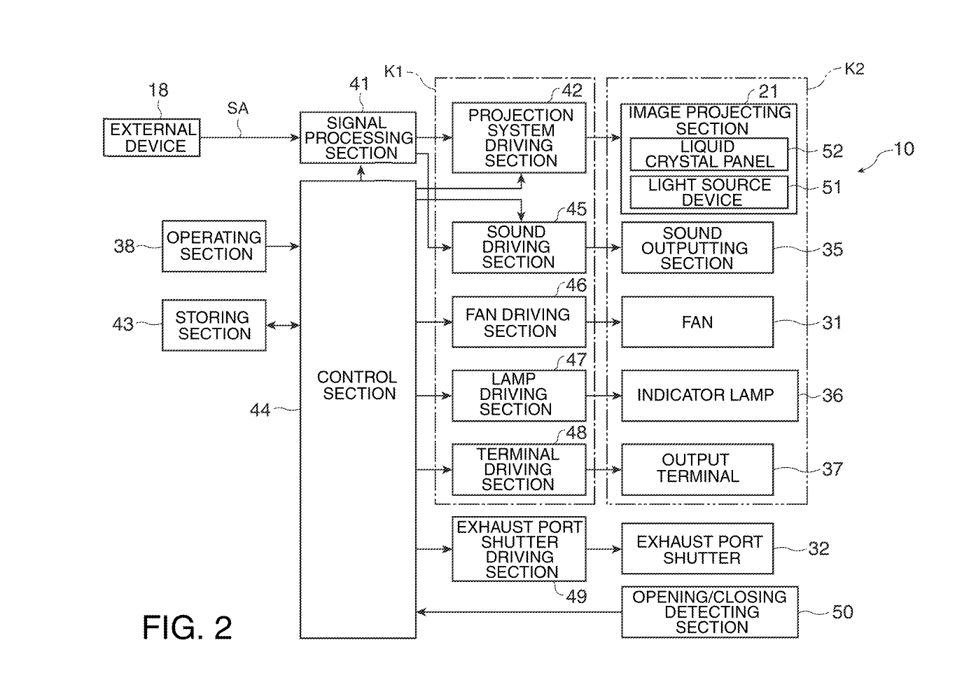

FIG. 1 is a diagram showing an internal structure of a projector (a projection display device) 10 according to the embodiment of the invention, and FIG. 2 is a block diagram showing a functional configuration of the projector 10.

As shown in FIG. 1, the projector 10 is a device including an image projecting section 21 projecting an image light representing an image and making the image projecting section 21 display an image (a projected image) on a screen (not shown) which is a projection surface. The projector 10 includes, inside a casing 11, a device main body 12 in which projector component parts such as the image projecting section 21 are provided and an outer cover (not shown) covering the device main body 12.

The casing 11 has a virtually rectangular shape in a plan view. In one of left and right side faces (shorter sides) 11L and 11R of the casing 11, a suction port 15 is provided, and, in the other side face, an exhaust port 16 is provided. Here, in FIG. 1, a front face of the casing 11 (a face in which a projection lens 53 of the image projecting section 21 is exposed) is assigned a reference character 11A, and aback face of the casing 11 is assigned a reference character 11B. A side face of the casing 11 which is located on the left side when the casing 11 is viewed from the front face 11A is depicted as a left side face 11L, and a side face of the casing 11 which is located on the right side when the casing 11 is viewed from the front face 11A is depicted as a right side face 11R.

Inside the casing 11, a cooling fan 31 is disposed on the side of the suction port 15, an exhaust port shutter 32 is disposed on the side of the exhaust port 16, and, in a region between the cooling fan 31 and the exhaust port shutter 32, the image projecting section 21 and a power source section 22 are disposed. Moreover, inside the casing 11, a circuit board 33 having a control section 44 and the like shown in FIG. 2 is also provided. The outer cover covers the casing 11 other than the suction port 15 and the exhaust port 16. As a result, outside air is introduced into the casing 11 through the suction port 15 by the cooling fan 31 and is exhausted through the exhaust port 16 after the individual sections such as the image projecting section 21 are cooled by the cooling air.

In the projector 10 with this structure, as shown in FIG. 1, in the suction port 15 which is one side of an opening for ventilation, a dust filter 34 is disposed, and, in the exhaust port 16 which is the other side of the opening for ventilation, the exhaust port shutter 32 that opens and closes the exhaust port 16 is disposed. Therefore, it is possible to prevent the entry of dust and insects through the openings 15 and 16. That is, the projector 10 is configured as a dustproof projector that is suitable for the use in a dust-prone region.

Moreover, the projector 10 with this structure is configured so that it can perform cooling by the cooling fan 31 when the individual sections such as the image projecting section 21 are operating and make it unnecessary to perform cooling by the cooling fan 31 immediately after the operations of the individual sections are stopped to improve the materials of these sections, for example.

The power source section 22 is supplied with power from an external power source which is a commercial power source sent from an electric power company by being connected, via an unillustrated plug, to a receptacle located inside a building or the like, and supplies power to the individual sections of the projector 10. That is, the projector 10 is driven by using the external power source as operating power.

The circuit board 33 has a signal processing section 41, a projection system driving section 42, a storing section 43, a control section 44, a sound driving section 45, a fan driving section 46, a lamp driving section 47, a terminal driving section 48, and an exhaust port shutter driving section 49 (see FIG. 2).

As shown in FIG. 2, the signal processing section 41 includes an image processing system that receives a video signal SA (in this configuration, a signal containing only an image or a signal containing both an image and sound) from an external device (such as a personal computer and a DVD player) 18 which is connected via a cable and performs image processing on image data corresponding to the signal SA and a sound processing system that performs sound processing on sound data corresponding to the signal SA.

Here, the image processing system performs IP conversion by which the format of the image data is converted from interlaced to progressive, resolution conversion processing on the image data subjected to IP conversion to increase or reduce the size, various kinds of color correction such as adjustment of the lightness and color saturation, and the like.

The projection system driving section 42 functions as a liquid crystal panel driving section and a light source driving section that drive a liquid crystal panel 52 and a light source device 51, respectively, of the image projecting section 21. The projection system driving section 42 drives the liquid crystal panel 52 and the light source device 51 based on the image data on which image processing has been performed by the signal processing section 41 and thereby makes the liquid crystal panel 52 and the light source device 51 display an image.

As shown in FIG. 1, the image projecting section 21 has a virtually L shape in a plan view, the L shape extending along the back face 11B which is one of the longer sides of the casing 11 and extending to the front face 11A along the side faces 11L and 11R which are shorter sides of the casing 11, and includes the light source device 51 functioning as a light source, the liquid crystal panel (which is also referred to as the liquid crystal light valve) 52 (52R, 52G, 52B), and the projection lens 53.

The light source device 51 includes a xenon lamp, an ultra-high pressure mercury lamp, an LED (light emitting diode), or the like. The liquid crystal panel 52 is formed as a transmissive liquid crystal panel in which a plurality of pixels are arranged in a matrix. The liquid crystal panel 52 modulates an illumination light (indicated by a reference character L in FIG. 1) from the light source device 51 into an image light representing an image by changing the light transmittance of each pixel by the driving of the projection system driving section 42, and makes the image light exit from the projection lens 53.

In this embodiment, a case in which the projector 10 is a three LCD projector is shown. In this case, as shown in FIG. 1, three liquid crystal panels 52R, 52G, and 52B corresponding to three colors R, G, and B and optical components (such as lenses 321 to 324, 341, and 343, a dimmer 325, dichroic mirrors 331 and 332, reflection mirrors 333, 342, and 344, polarizing plates 351 and 353, and a prism 354) for performing separation and condensing of the light from the light source device 51 are provided.

With this configuration, it is possible to generate a color image by separating the light from the light source device 51 into lights of three colors R, G, and B, making the lights pass through the liquid crystal panels 52R, 52G, and 52B, and combining the lights with the prism 354. Incidentally, the configuration of the image projecting section 21 is not limited to the configuration shown in FIG. 1, and a wide range of publicly known configurations can be adopted. Moreover, a publicly known configuration having one liquid crystal panel 52 may be adopted.

As shown in FIG. 2, various kinds of program products such as a control program product and various kinds of data are stored in the storing section 43.

The control section 44 functions as a computer controlling the individual sections of the projector 10 by reading and executing the control program product stored in the storing section 43.

The projector 10 is further provided with a sound outputting section 35 formed of a speaker and the like, an indicator lamp (in this embodiment, an LED) 36 for notifying the user of the operating state (power-on, a standby state, an error state, and the like) of the projector 10, an output terminal 37 (a TriggerOut terminal outputting TriggerOut to an unillustrated external device, a USB terminal, and the like) outputting TriggerOut and a power signal (USB bus power), an operating section 38 having various kinds of operators used by the user to giving various instructions, and the like.

Under control of the control section 44, the sound driving section 45 drives the sound outputting section 35 of the projector 10 and makes the sound outputting section 35 produce various kinds of sound corresponding to the sound data output from the signal processing section 41, such as sound, operation sound, and beep sound.

Under control of the control section 44, the lamp driving section 47 turns on/off each indicator lamp 36 by driving/not driving a plurality of indicator lamps (notifying sections) 36 (including making them flash) selectively, and thereby notifies the user of power-on, a standby state (a state in which greater power savings are achieved than in a power-on state: a state in which part of functions is enabled (for example, a state in which operation of a main body operating section (the operating section 38) and operation of an unillustrated remote control are accepted and a standby monitor out function is enabled)), an error state, and the like.

Under the control section 44, the terminal driving section 48 outputs TriggerOut for notifying an external device (such as a screen apparatus) of power-on of the projector 10 and a power signal for supplying power to a USB external device to the outside via the output terminal 37.

Under control of the control section 44, the exhaust port shutter driving section (the shutter driving section) 49 drives the exhaust port shutter 32 so that the exhaust port shutter 32 is opened/closed. When the power is turned on by the operation performed on the operating section 38, the exhaust port shutter driving section drives the exhaust port shutter 32 so that it is opened; when the power is turned off by the operation performed on the operating section 38, the exhaust port shutter driving section drives the exhaust port shutter 32 so that it is closed.

The opening/closing detecting section 50 is a switch mechanism that detects opening and closing of the exhaust port shutter 32. The control section 44 can detect the open/closed state of the exhaust port shutter 32 by obtaining the detection result of the opening/closing detecting section 50.

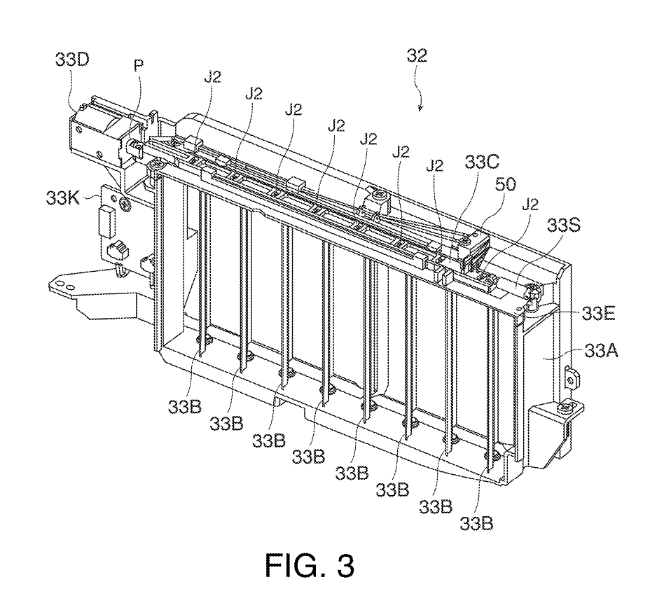

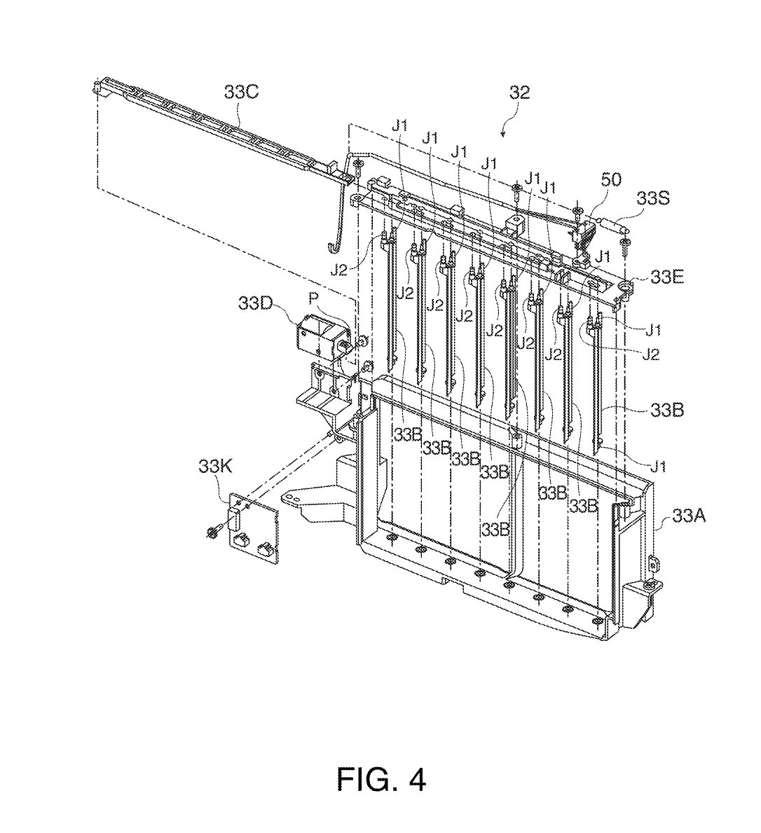

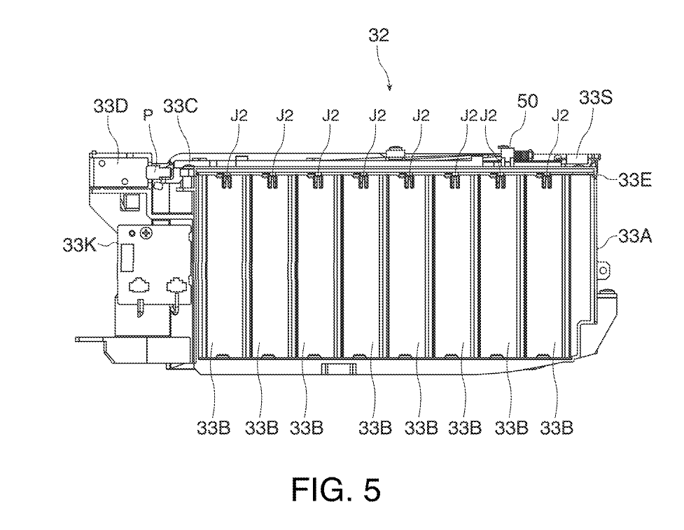

Here, FIG. 3 is a perspective view showing an open state of the exhaust port shutter 32, and FIG. 4 is an exploded perspective view of the exhaust port shutter 32. FIG. 5 is a diagram showing a closed state of the exhaust port shutter 32.

As shown in FIGS. 3 to 5, the exhaust port shutter 32 includes a frame 33A having a shape of a rectangular frame, a plurality of (in this structure, eight) louvers 33B which are placed at regular spacings in a longitudinal direction in such away as to be able to open and close an opening (an opening communicating with the exhaust port 16) of the frame 33A, a cam plate 33C which is slidably placed in the frame 33A, and a solenoid 33D that operates the cam plate 33C.

As shown in FIG. 4, the frame 33A includes a plate-like member 33E forming part of an upper frame as a separate component, and turnably supports a turning shaft J1 jutting from the upper and lower ends of each louver 33B by a lower frame of the frame 33A and the plate-like member 33E.

On the plate-like member 33E, the cam plate 33C is slidably supported, and a projecting shaft J2 jutting upward with a space left between the projecting shaft J2 and the turning shaft J1 of each louver 33B is placed through the cam plate 33C.

As a result, when the cam plate 33C is slid, all the louvers 33B turn about the turning shafts J1 and open and close the opening of the frame 33A.

The solenoid 33D is fixed to the frame 33A, and a plunger P of the solenoid 33D is connected to one end of the cam plate 33C. Incidentally, in the drawing, a reference character 33K denotes a circuit board for driving the solenoid.

In the exhaust port shutter 32, a biasing member (in this embodiment, an extension spring) 33S which biases the cam plate 33C to a shutter close side is provided. The biasing member 33S makes it possible to keep the exhaust port shutter 32 in a closed state reliably.

The solenoid 33D is a keep solenoid (also called a self-holding solenoid). As a result of the cam plate 33C being pulled toward the solenoid 33D against the biasing force of the biasing member 33S by the exhaust port shutter driving section 49, the exhaust port shutter 32 is driven so that it is opened (sucking operation of the solenoid), and the exhaust port shutter 32 is kept in an open state as a result of the plunger P of the solenoid 33D sticking to a built-in permanent magnet thereto by the magnetomotive force of the built-in permanent magnet (sticking operation of the solenoid).

Moreover, the solenoid 33D drives the exhaust port shutter 32 so that it is closed by restoring to a state before the plunger P sticks to the built-in permanent magnet by a reverse magnetomotive force which is generated by a coil and cancels out the magnetomotive force of the built-in permanent magnet by the exhaust port shutter driving section 49 (restoring operation of the solenoid).

Incidentally, the opening/closing detecting section 50 that detects opening and closing of the exhaust port shutter 32 is formed as a switch mechanism that is attached to the plate-like member 33E of the exhaust port shutter 32 and opens and closes in accordance with the position of the cam plate 33C.

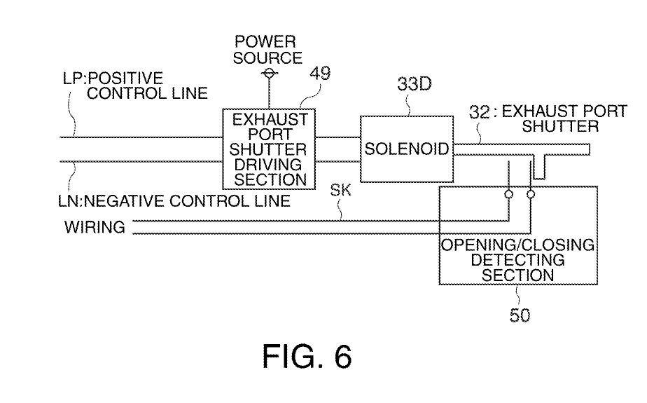

FIG. 6 is a diagram showing the solenoid 33D along with peripheral components.

As shown in FIG. 6, to the solenoid 33D, two control lines formed of a positive control line LP and a negative control line LN are connected. As a result of the control section 44 changing the voltage applied to each of the control lines LP and LN and the direction in which the voltage is applied thereto, the solenoid 33D is operated and the exhaust port shutter 32 is driven so that it is opened/closed.

The switch mechanism is turned on/off as a result of a protruding portion 33C1 (see FIG. 6) provided in the cam plate 33C making contact with the opening/closing detecting section 50. More specifically, when the exhaust port shutter 32 is opened, the opening/closing detecting section 50 is brought into an on state, and the potential of the wiring which connects to the opening/closing detecting section 50 becomes H level; when the exhaust port shutter 32 is closed completely, the opening/closing detecting section 50 is brought into an off state, and the potential of the wiring becomes L level.

The control section 44 receives the signal of the wiring as a detection signal SK, and can detect whether the exhaust port shutter 32 is opened or closed in accordance with the signal level of the detection signal SK.

Incidentally, since the projector 10 is a dustproof projector, the projector 10 can prevent reliably the entry of dust and insects from the outside when the projector 10 is left as it is or carried around by keeping the exhaust port shutter 32 in a closed state when the projector 10 is not used.

However, when a malfunction occurs in the exhaust port shutter 32, there is a possibility that the exhaust port shutter 32 is not opened and is kept closed at the time of startup when the power is turned on and adequate cooling cannot be performed, or the exhaust port shutter 32 is kept opened without being closed when the power is turned off and the operation is stopped.

In this configuration, to address the occurrence of such a malfunction of the exhaust port shutter 32, startup shutter control (also referred to as power-on shutter control) is performed at the time of startup, shutter monitoring processing is performed after startup, and operation stop shutter control (also referred to as power-off shutter control) is performed when the operation is stopped.

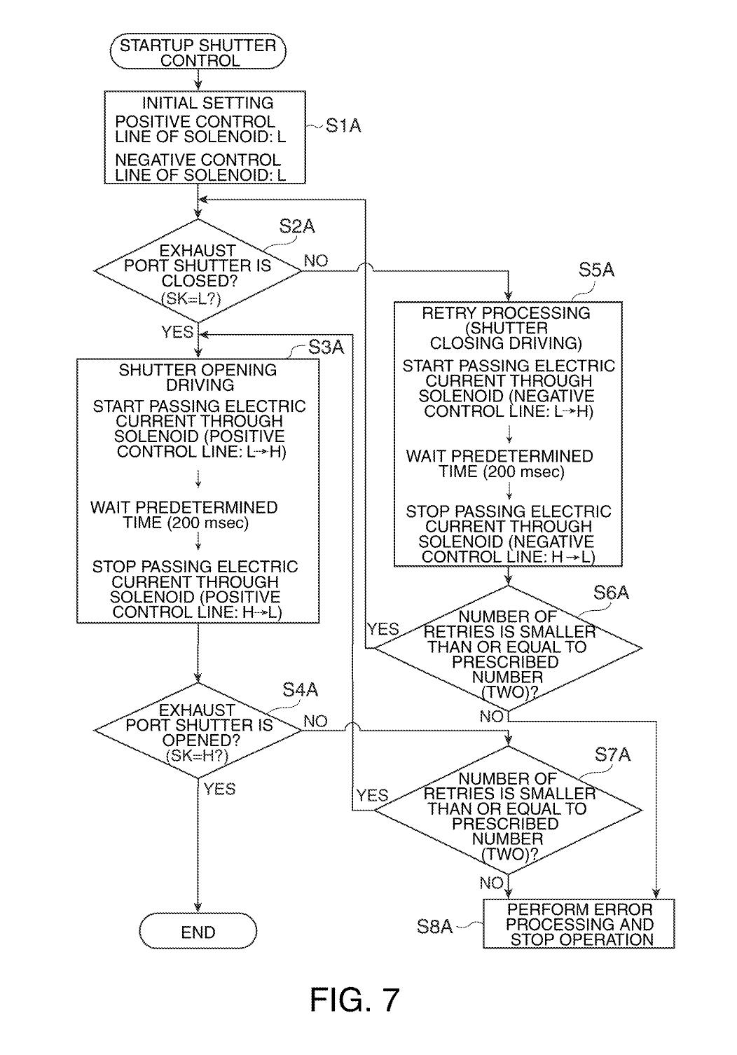

FIG. 7 is a flowchart showing the startup shutter control.

Prior to description of this control, a precondition will be described. In the projector 10, the exhaust port shutter 32 is driven so that it is closed when the power is turned off, and the exhaust port shutter 32 is closed when the projector 10 is not used. Incidentally, shutter close driving at the time of power off is described in the operation stop shutter control (power-off shutter control) which will be described later.

Moreover, in the following description, when the exhaust port shutter driving section 49 and the other driving sections 42 to 48 are described separately, the other driving sections 42 to 48 are collectively expressed as a driving section K1 (indicated as apart enclosed with an alternate long and dashed line in FIG. 2), and the objects to be driven by the driving section K1 are collectively expressed as a driven section K2 (indicated as a part enclosed with a chain-double dashed line in the drawing).

The startup shutter control is performed when a “Power” key provided in the operating section 38 is operated by the user and the startup processing by the control section 44 is started. More specifically, when the “Power” key is operated, the control section 44 performs the “startup shutter control” prior to the startup processing of the driven section K2 other than the exhaust port shutter 32. That is, the “startup shutter control” is performed prior to the startup of the image projecting section 21 which is accompanied by a relatively large amount of heat generation by the light source device 51 or the like and prior to the start of the driving of the cooling fan 31.

As shown in FIG. 7, the control section 44 first sets the positive control line LP and the negative control line LN at L level by the exhaust port shutter driving section 49, and initializes the solenoid 33D in a state in which no electric current is passed therethrough (step S1A). Then, after a predetermined waiting time (for example, 10 msec) has elapsed, the control section 44 determines whether or not the exhaust port shutter 32 is closed based on the detection signal SK of the opening/closing detecting section 50 (step S2A).

Here, if the exhaust port shutter 32 is operating normally, the exhaust port shutter 32 is supposed to be closed. If the exhaust port shutter 32 is closed (step S2A: YES), the control section 44 drives the exhaust port shutter 32 so that it is opened by the exhaust port shutter driving section 49 (step S3A).

In step S3A, the control section 44 makes the solenoid 33D start sucking operation by setting the level of the positive control line LP at H level and starting passing electric current through the solenoid 33D by the exhaust port shutter driving section 49. After waiting a predetermined time (in this configuration, 200 msec), the control section 44 switches the positive control line LP to L level and stops passing electric current through the solenoid 33D.

Here, the reason to provide a waiting time is to secure sufficient time for the sucking operation of the solenoid 33D and buy sufficient time to drive the exhaust port shutter 32 so that it is opened.

Then, the control section 44 determines whether or not the exhaust port shutter 32 is opened based on the detection signal SK of the opening/closing detecting section 50 (step S4A). If the exhaust port shutter 32 is opened (step S4A: YES), the control section 44 ends the “startup shutter control”. That is, when the exhaust port shutter 32 operates normally and is opened, the control section 44 ends the control.

In this case, since the exhaust port shutter 32 operates normally, the control section 44 starts driving of the driven section K2 by the driving section K1 other than the exhaust port shutter driving section 49, starts startup of the image projecting section 21 which is accompanied by a relatively large amount of heat generation by the light source device 51 or the like and driving of the fan, and performs normal operation. As a result, the user can view the image from the external device 18 by using the projector 10.

On the other hand, if it is determined in step S2A that the exhaust port shutter 32 is not closed (step S2A: NO), that is, the open/closed state of the shutter 32 is different from that in a normal state (in other words, the open/closed state of the shutter 32 is an abnormal state), the control section 44 determines that there is an abnormality, drives the exhaust port shutter 32 so that it is closed, and retries shutter closing driving which is supposed to have been already performed (step S5A).

In step S5A, the control section 44 starts passing electric current through the solenoid 33D by inverse characteristics by changing the level of the negative control line LN to H level by the exhaust port shutter driving section 49, and makes the solenoid 33D start restoring operation. Then, after waiting a predetermined time (in this configuration, 200 msec), the control section 44 switches the negative control line LN to L level and stops passing electric current through the solenoid 33D. Here, the reason to provide a waiting time is to secure sufficient time for the restoring operation of the solenoid 33D and buy sufficient time to drive the exhaust port shutter 32 so that it is closed.

Then, if the number of retries (the number of retries of the shutter closing driving after the start of the “startup shutter control”) is smaller than or equal to a prescribed number (in this embodiment, two) (step S6A: YES), the control section 44 goes back to processing in step S2A.

Therefore, if the exhaust port shutter 32 is closed by a retry (step S2A: YES), the exhaust port shutter 32 is driven so that it is opened (step S3A). If the exhaust port shutter 32 is opened (step S4A: YES), the normal operation of the exhaust port shutter 32 can be confirmed, whereby it can be determined that restoration has been completed. Thus, the control section 44 ends the control, starts the projector 10, and makes the projector 10 operate normally.

On the other hand, if the shutter 32 is not closed even by performing a retry (step S2A: NO), the control section 44 retries the shutter closing driving again (step S5A).

If the exhaust port shutter 32 is not closed even after performing the retry in this manner, when the number of retries exceeds a prescribed number (two) (step S6A: NO), that is, the number of retries becomes three, it can be determined that the exhaust port shutter 32 is in a state in which the exhaust port shutter 32 cannot be driven so that it is closed. Therefore, the control section 44 performs error processing immediately (step S8A).

In this case, as the error processing, the control section 44 performs 1) notification processing by which the indicator lamp 36 is driven by the lamp driving section 47 (in this configuration, the indicator lamp 36 is driven to produce flashing red light) and thereby notifying the user of the error state, 2) history processing by which error information indicating that the exhaust port shutter 32 is in an error state in which the exhaust port shutter 32 cannot be driven so that it is closed is written into the storing section 43 or unillustrated flash ROM provided outside the storing section 43 and is left as an error history, 3) processing by which, if the cooling fan 31 is being driven, the driving of the cooling fan 31 is immediately stopped, and, if the image projecting section 21 including the light source device 51 is being driven, the driving of the image projecting section 21 is immediately stopped, and other processing.

As a result, the user or the like is allowed to know that the projector 10 is in an error state, and an maintenance agency or the like can determine the kind of error which has occurred by reading the error history from the storing section 43 or the like or projecting the error history onto the screen at the time of maintenance. In addition, it is possible to avoid reliably the circumstances under which the individual sections of the projector 10 are operated with the exhaust port shutter 32 closed.

Incidentally, when the projector 10 has a network terminal and is connected to the external device (the personal computer) 18 or the like via the network terminal, as the error processing, 4) informing processing by which electronic mail or an error signal in which error information is described is sent to the external device may be performed. Moreover, in this embodiment, a case in which the “startup shutter control” is performed prior to the startup processing of the driven section K2 has been described; however, the “startup shutter control” may be performed in conjunction with the startup processing of the driven section K2. When the “startup shutter control” is performed in conjunction with the startup processing of the driven section K2, it is preferable that, if there is an abnormality in the exhaust port shutter 32, the driving of the driven section K2 be stopped immediately as error processing.

Moreover, if the shutter 32 is not opened by the shutter opening driving in step S3A even when the exhaust port shutter 32 is closed by the retry performed by the shutter closing driving (step S4A: NO), the control section 44 goes back to the processing in step S3A if the number of retries of the shutter opening driving (the number of retries of the shutter opening driving after the start of the “startup shutter control”) is smaller than or equal to a prescribed number (in this embodiment, two) (step S7A: YES), and retries the shutter opening driving.

Then, if the number of retries of the shutter opening driving exceeds the prescribed number (two) (step S7A: NO), that is, when the number of retries becomes three, it can be determined that the exhaust port shutter 32 is in a state in which the exhaust port shutter 32 cannot be driven so that it is opened, the control section 44 performs error processing immediately (step S8A).

In this case, the control section 44 provides notification of an error by performing the error processing 1) to 4) described above, and reliably avoids the circumstances under which the individual sections of the projector 10 are operated in a state in which the exhaust port shutter 32 is not opened.

Incidentally, in the error processing performed when the exhaust port shutter 32 cannot be driven so that it is opened, the error information indicating an error state in which the exhaust port shutter 32 cannot be driven so that it is opened is left as an error history. Moreover, the driving of the indicator lamp 36 in this case may be performed differently (for example, by changing the intervals between flashing red lights) from the driving performed when the exhaust port shutter 32 cannot be driven so that it is closed.

As described above, when the exhaust port shutter 32 cannot be driven so that it is closed or opened, the control section 44 performs retry control by which the shutter 32 is operated, and, when the control section 44 still cannot restore the state to a normal state, the control section 44 performs the error processing. After performing the error processing, the control section 44 stops the driving of the entire projector 10 when a predetermined time has elapsed. This makes it possible to avoid the circumstances under which the projector 10 is started in a state in which the abnormality in the exhaust port shutter 32 cannot be corrected. This is the end of the description of the “startup shutter control”.

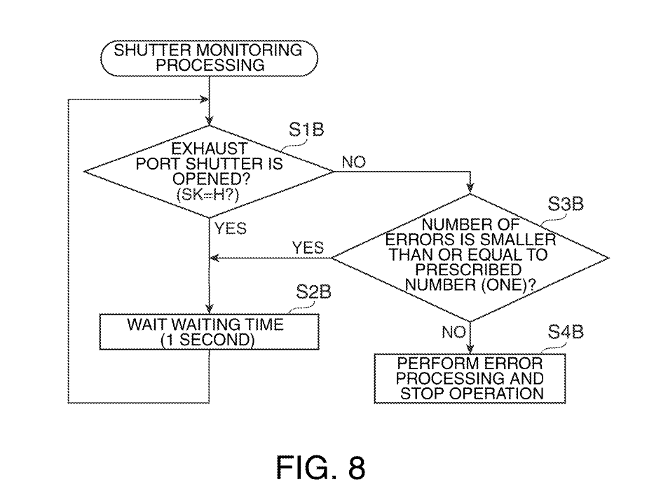

FIG. 8 is a flowchart showing the shutter monitoring processing after startup.

When the projector 10 starts, as shown in FIG. 8, the control section 44 determines whether or not the exhaust port shutter 32 is opened based on the detection signal SK of the opening/closing detecting section 50 (step S1B). If the exhaust port shutter 32 is opened (step S1B: YES), after waiting a predetermined waiting time (in this embodiment, 1 second) (step S2B), the control section 44 goes back to step S1B and determines whether or not the exhaust port shutter 32 is opened. That is, the control section 44 continuously monitors the exhaust port shutter 32 whether or not it is opened at intervals of the waiting time.

If the control section 44 detects that the exhaust port shutter 32 is not opened (step S1B: NO), the control section 44 regards the number of times that it is detected that the exhaust port shutter 32 is not opened as the number of errors, and determines whether or not the number of errors (the number of errors after the start of the “shutter monitoring processing”) is smaller than or equal to a prescribed number (in this embodiment, smaller than or equal to one) (step S3B).

If it is determined in step S3B that the number of errors is smaller than or equal to the prescribed number (step S3B: YES), the control section 44 goes back to the processing in step S2B. If the number of errors exceeds the prescribed number (if the number of errors is two), the control section 44 determines that a malfunction occurs in the exhaust port shutter 32 and immediately performs the error processing and stops the operations of the individual sections of the projector 10 (step S4B).

As the error processing, as is the case with the error processing in step S8A described above, 1) notification processing by which the indicator lamp 36 is driven by the lamp driving section 47, 2) history processing by which the error information is left as an error history, 3) processing by which, if the cooling fan 31 is being driven, the driving of the cooling fan 31 is immediately stopped, and, if the image projecting section 21 including the light source device 51 is being driven, the driving of the image projecting section 21 is immediately stopped, and 4) informing processing by which, if a network terminal is provided, the external device is informed of the error information are performed. This is the end of the description of the “shutter monitoring processing”.

Therefore, when the number of times that the exhaust port shutter 32 is not opened after the startup of the projector 10 due to a malfunction exceeds a prescribed number, the user or the like is immediately notified of this state by the error processing and the operation of the projector 10 is stopped. As a result, the user or the like is immediately notified of a shutter abnormality during normal operation, and it is possible to prevent an increase in the internal temperature.

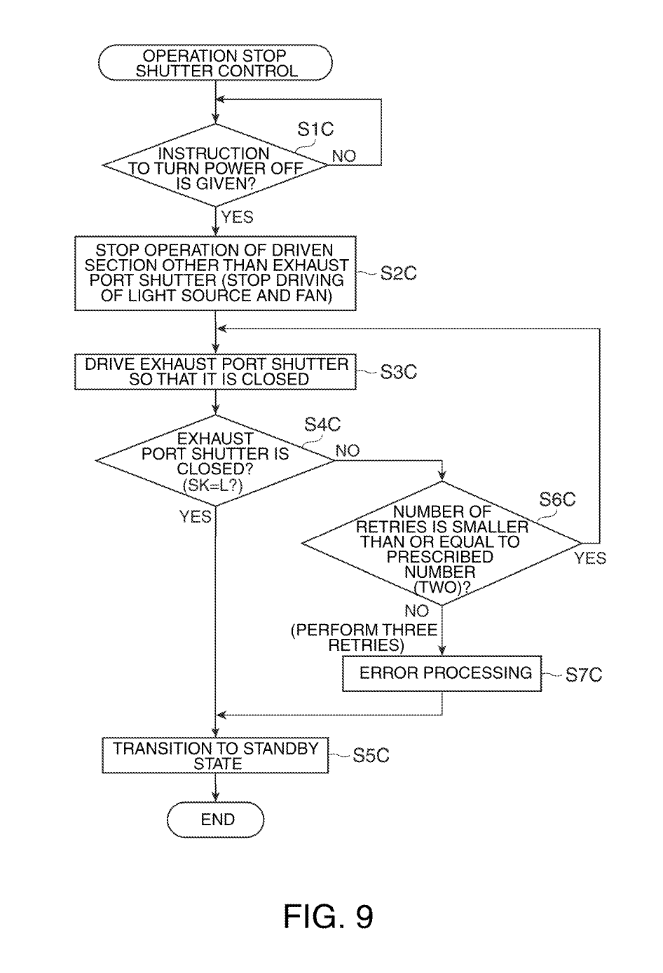

FIG. 9 is a flowchart showing the operation stop shutter control (the power-off shutter control).

This control is performed when the “Power” key provided in the operating section 38 is operated by the user after the startup of the projector 10 to give an instruction to turn the power off. Incidentally, power-off is a state in which the operation is stopped when the user does not use the projector 10 and a state in which cooling is not necessary because at least the driving of the image projecting section 21 is stopped and almost no heat is generated in the device main body 12.

The control section 44 performs monitoring to determine whether or not an instruction to turn the power off is given (step S1C). If an instruction to turn the power off is given (step S1C: YES), the control section 44 stops the driving of the driven section K2 other than the exhaust port shutter 32 by the driving section K1 (step S2C). That is, the control section 44 stops the driving of the portions related to heat generation and cooling, such as the light source device 51 and the cooling fan 31.

After the light source device 51, the cooling fan 31, and the like are stopped, the control section 44 drives the exhaust port shutter 32 so that it is closed by the exhaust port shutter driving section 49 (step S3C). Then, the control section 44 determines whether or not the exhaust port shutter is closed based on the detection signal SK of the opening/closing detecting section 50 (step S4C).

Here, the exhaust port shutter 32 is supposed to be closed if the exhaust port shutter 32 operates normally. If the exhaust port shutter 32 is closed (step S4C: YES), the control section 44 brings the device main body 12 into a standby state and ends this control (step S5C).

The standby state is a state in which the device main body 12 can be started. Specifically, the standby state is a state in which the device main body 12 is immediately started when an instruction to turn the power on is given as a result of the “Power” key provided in the operating section 38 being operated by the user. Incidentally, no operation from the outside is accepted until the state becomes the standby state.

On the other hand, if the exhaust port shutter 32 is not closed (step S4C: NO), the control section 44 determines whether or not the number of retries of driving to close the exhaust port shutter 32 (the number of retries after the start of the “power-off shutter control”) is smaller than or equal to a prescribed number (in this embodiment, smaller than or equal to two) (step S6C). If the number of retries of driving to close the exhaust port shutter 32 is smaller than or equal to the prescribed number (step S6C: YES), the control section 44 goes back to processing in step S3C and retries the driving to close the exhaust port shutter 32.

If the exhaust port shutter 32 is not closed even after performing the retry, when the number of retries exceeds the prescribed number (two) (step S6C: NO), that is, when the number of retries becomes three, the control section 44 determines that it is in a state in which the exhaust port shutter 32 cannot be driven so that the exhaust port shutter 32 is closed and immediately performs error processing (step S7C).

As the error processing, as is the case with the error processing in steps S8A and S4B described above, 1) notification processing by which the indicator lamp 36 is driven by the lamp driving section 47, 2) history processing by which the error information is left as an error history, and 3) informing processing by which, when a network terminal is provided, an external device is informed of the error information are performed.

This makes it possible to notify the user or the like of an abnormality when the exhaust port shutter 32 is not closed when the driving of the projector 10 is stopped. Therefore, it is possible to avoid the circumstances under which the projector 10 is left as it is without the user being aware of a state in which the exhaust port shutter 32 is not closed.

Moreover, when a predetermined time has elapsed after the error processing, the control section 44 stops the driving of the individual sections of the projector 10 and transitions to a standby state (step S5C), and ends the control. This makes it possible to stop the driving of the individual sections reliably even when the exhaust port shutter 32 is not closed when the driving of the projector 10 is stopped.

Moreover, since the transition to the standby state is performed after the driving is stopped, the projector 10 starts when the user gives an instruction to turn the power on, and, if the exhaust port shutter 32 operates normally at that time, the user can use the projector 10. This is the end of the description of the “operation stop shutter control”.

Here, since the “startup shutter control” described above is performed at the time of startup, it is possible to avoid reliably the circumstances under which the individual sections of the projector 10 are operated in a state in which the exhaust port shutter 32 does not operate normally at the time of startup.

As described above, when stopping the operation of the projector 10 (when stopping the operation of the device main body 12), the control section 44 performs control to close the exhaust port shutter 32 and detects whether or not the exhaust port shutter 32 is closed. If the exhaust port shutter 32 is not closed, the control section 44 retries the control to close the exhaust port shutter 32. If the exhaust port shutter 32 is not closed even with the retry, the control section 44 performs error processing and then makes the projector 10 transition to a standby state in which startup is possible. Therefore, only when an abnormality in the exhaust port shutter 32 is confirmed when the operation is stopped and the shutter abnormality cannot be corrected even with the retry, error processing can be performed. This makes it possible to avoid the circumstances under which the error processing is performed even when the shutter abnormality can be corrected and perform processing corresponding to the abnormality appropriately.

Furthermore, in this configuration, since the state transitions to a standby state in which startup is possible after error processing, it is possible to start the projector 10 even after providing notification about an error indicating a state in which the exhaust port shutter 32 is not closed.

As described above, since the projector 10 with this configuration is a dustproof projector, an error indicating that the exhaust port shutter 32 is not closed when the projector 10 is not used, the error which is undesirable from the viewpoint of dustproofing, should not be left as it is. On the other hand, however, this error has no detrimental effect on the startup and operation of the projector 10. With the configuration described above, in the invention, it is possible to start the projector 10 and bring it into a usable state while reliably notifying the user or the like of an error indicating a state in which the exhaust port shutter 32 is not closed.

Incidentally, in this configuration, since the “startup shutter control” is performed at the time of startup, when an abnormality in the open/closed state of the exhaust port shutter 32 is confirmed at the time of startup and this abnormality can be corrected, the projector 10 can be started and used. Therefore, if the exhaust port shutter 32 operates normally until the projector 10 is started or at the time of startup of the projector 10, it is possible to use the projector 10 normally; if the exhaust port shutter 32 does not operate normally at the time of startup of the projector 10, it is possible to avoid the circumstances under which the projector 10 operates in a state in which the exhaust port shutter 32 does not operate normally.

Moreover, the control section 44 performs control to close the shutter after stopping the driving of the image projecting section 21 and the cooling fan 31 when the operation of the projector 10 is stopped and detects whether or not the shutter is closed. This makes it possible to close the shutter 32 after stopping the driving of the portions related to heat generation and cooling and thereby avoid reliably the circumstances under which the internal temperature is increased.

Furthermore, the exhaust port shutter 32 is opened and closed by the driving of the solenoid 33D, and the exhaust port shutter driving section 49 passes electric current through the solenoid 33D and drives the exhaust port shutter 32 so that it is closed. As a result, as compared to a case in which the exhaust port shutter 32 is driven by a motor so that it is closed, it is possible to close the exhaust port shutter 32 in a short time. This makes it possible to shorten the time necessary for a retry when the operation is stopped, for example.

In addition, in this configuration, the biasing member 33S biasing the exhaust port shutter 32 to a close side is provided, and the exhaust port shutter 32 is closed by the biasing force of the biasing member 33S by releasing the holding force of the solenoid 33D. Therefore, even when a malfunction occurs in the solenoid 33D, the biasing member 33S makes it easier to close the exhaust port shutter 32.

Moreover, at the time of startup of the projector 10 (at the time of startup of the device main body 12), before starting the driving of the image projecting section 21, the control section 44 determines whether or not the exhaust port shutter 32 is closed. If the exhaust port shutter 32 is not closed, the control section 44 performs retry control to close the exhaust port shutter 32. If the exhaust port shutter 32 is still not closed, the control section 44 performs error processing; if the exhaust port shutter 32 is closed, the control section 44 drives the exhaust port shutter 32 so that it is opened. If the exhaust port shutter 32 is not opened, the control section 44 performs retry control to open the exhaust port shutter 32. If the exhaust port shutter 32 is not opened, the control section 44 performs error processing.

That is, in this configuration, it is determined whether or not there is an abnormality in the open/closed state of the exhaust port shutter 32 at the time of startup. If it is determined that there is an abnormality, retry control is performed. If the shutter 32 does not operate normally, error processing is performed, whereby the user or the like is notified of a breakdown in the shutter.

Therefore, only when an abnormality in the exhaust port shutter 32 is confirmed at the time of startup and the shutter abnormality cannot be corrected even with the retry, error processing can be performed. This makes it possible to avoid the circumstances under which the error processing is performed even when the shutter abnormality can be corrected and perform processing corresponding to the abnormality appropriately.

As described above, since the projector 10 with this configuration is provided with the dust filter 34 in the suction port 15, the entry of dust and insects through the suction port 15 is prevented by the dust filter 34. Therefore, by closing the exhaust port 16 with the exhaust port shutter 32, a vent hole of the projector 10 is closed, whereby it is possible to prevent dust and insects from entering the projector 10 reliably.

In this configuration, as the dustproof shutter, the circumstances where an abnormality causing a state in which the exhaust port shutter 32 is not closed should be avoided. In this configuration, since error processing is performed when the abnormality is not corrected by a retry, it is possible to avoid the circumstances under which the abnormality is left uncorrected.

Furthermore, in this configuration, if the individual sections operate with the exhaust port shutter 32 closed, the internal temperature of the device main body 12 is increased. However, in this configuration, since the startup is stopped if the exhaust port shutter 32 remains closed after a retry before the driving of the image projecting section is started, it is possible to avoid reliably the circumstances under which the internal temperature is increased.

Moreover, since the control section 44 determines whether or not there is an abnormality in the open/closed state of the exhaust port shutter 32 at the time of startup of the device main body 12 before the driving of the image projecting section 21 and the cooling fan 31 is started, it is possible to determine whether or not there is a shutter abnormality before the driving of the portions related to heat generation and cooling is started. This also makes it possible to avoid the circumstances under which the internal temperature is increased and avoid the circumstances under which the fan is driven in a state in which the exhaust port shutter 32 is closed.

Furthermore, since the control section 44 retries control to close the exhaust port shutter 32 when the exhaust port shutter 32 is not closed at the time of startup and performs error processing when the exhaust port shutter 32 is not closed even with the retry, it is possible to avoid the circumstances that allow easy entry of dust and insects.

Moreover, the control section 44 performs control to open the exhaust port shutter 32 before starting the driving of the image projecting section 21. If the exhaust port shutter 32 is not opened, the control section 44 retries control to open the exhaust port shutter 32. If the exhaust port shutter 32 is not opened even with the retry, the control section 44 performs error processing. This makes it possible to avoid the circumstances under which the image projecting section 21 is driven in a state in which the exhaust port shutter 32 is not opened and avoid reliably the circumstances under which the internal temperature is increased.

As described above, in this configuration, the operation to close the exhaust port shutter 32 and the operation to open the exhaust port shutter 32 are checked at the time of startup, it is possible to check both the operation to open the exhaust port shutter 32 and the operation to close the exhaust port shutter 32.

In addition, in this configuration, after the startup of the device main body 12, shutter monitoring processing (see FIG. 7) by which monitoring is performed to determine whether or not the exhaust port shutter 32 is opened and error processing is performed if the exhaust port shutter 32 is not opened is performed. This makes it possible to avoid the circumstances where a state in which the exhaust port shutter 32 is closed by a malfunction of some kind (for example, a malfunction caused by an impact from the outside) after the startup and the internal temperature tends to increase is left as it is.

The embodiment described above is merely an embodiment of the invention, and any modifications and applications are possible within the scope of the subject matter of the invention.

For example, in the embodiment described above, a case in which the exhaust port shutter 32 is provided has been described; however, the invention is not limited thereto. A shutter may be provided in the suction port 15, or the projection lens 53 may be provided with a shutter for protecting a lens (a lens shutter). In short, the invention can be widely applied to detection of an abnormality in a shutter which is opened and closed at the time of startup and when the operation is stopped and to error processing.

Moreover, the projector 10 described above is a projector that projects an image onto a screen by using the transmissive liquid crystal panel 52. However, the projector 10 may be a projector using a reflective liquid crystal panel or a DMD projector using a digital mirror device. Furthermore, the invention is not limited to a three LCD projector that projects a color image by the three liquid crystal panels 52; the invention can also be applied to a projector that projects a color image by displaying an image corresponding to RGB by time division by using one liquid crystal light valve, a single-panel DMD projector provided with a color wheel, and a three DMD projector. In short, the invention can be widely applied to a projection display device having a shutter.

What is claimed is:

1. A projection display device comprising:
a device main body including an image projecting section projecting an image;
a shutter that opens and closes an opening for ventilation, the opening of the device main body;
a shutter driving section driving the shutter;
an opening/closing detecting section detecting an open/closed state of the shutter; and
a control section that performs, in case that stopping the operation of the device main body, control to close the shutter by the shutter driving section, makes the opening/closing detecting section detect whether or not the shutter is closed, retries the control to close the shutter if the shutter is not closed, performs error processing in case that the shutter is not closed even if the number of retries controlling to close the shutter is more than a prescribed number, and, after the error processing, makes the device main body transition to a state in which the device main body can start.

2. The projection display device according to claim 1, wherein
the device main body has a fan sending air to the opening, and
the control section performs, in case that stopping the operation of the device main body, the control to close the shutter after stopping the driving of the image projecting section and the fan.

3. The projection display device according to claim 1, wherein
the shutter is opened and closed by the driving of a solenoid, and
the shutter driving section drives the shutter so that the shutter is closed by passing electric current through the solenoid.

4. The projection display device according to claim 3, wherein
the shutter has a biasing member biasing the shutter to a close side, and
the shutter driving section closes the shutter by a biasing force of the biasing member.

5. The projection display device according to claim 1, wherein
the device main body has a suction port covered with a dust filter and an exhaust port functioning as the opening that is closed as a result of the shutter being closed.

6. The projection display device according to claim 1, wherein
the control section retries the control to close the shutter a prescribed number of times and performs the error processing in case that the number of retries exceeds the prescribed number of times.

7. The projection display device according to claim 1, wherein
the control section provides notification of the occurrence of the error processing as error information.

8. A method for controlling a projection display device including a device main body provided with an image projecting section projecting an image, a shutter that opens and closes an opening for ventilation, the opening of the device main body, a shutter driving section driving the shutter, and an opening/closing detecting section detecting an open/closed state of the shutter, comprising the steps of:
controlling the shutter driving section to close the shutter in case that the operation of the device main body is stopped,
detecting whether or not the shutter is closed by the opening/closing detecting section,
retrying control to close the shutter if the shutter is not closed,
performing error processing in case that the shutter is not closed even if the number of retries controlling to close the shutter is more than a prescribed number,
transitioning to a state in which the device main body can start after the error processing.
